(19) United States
(12) Patent Application Publication
(10) Pub. No.: US 2007/0040369 A1
(43) Pub. Date: Feb. 22, 2007

(54) Mobile lift assembly

(76) Inventor: David Barry Lotman, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/204,858

(22) Filed: Aug. 16, 2005

(51) Int. Cl. B60S 9/02

(52) U.S. Cl. 280/763.1

(57) ABSTRACT

A lift assembly which is operable by pressurized fluids and constructed to movably support a vehicle, in the event of a flat tire or similar emergency. The lift assembly is mounted at a predetermined location on the vehicle adjacent the wheels and includes means to pivot it into and out of its operational position. The lift assembly includes a support assembly including at least one support member constructed to travel along a road on which the vehicle is located and further includes a lift mechanism, operable by pressurized fluid, to raise the vehicle and flat tire above the road surface.

### FIELD OF THE INVENTION

The present invention generally relates to a lift assembly for a vehicle. The invention particularly relates to a lift assembly which is operable by a pressurized fluid to raise a portion of the vehicle which is associated with a flat tire, and most particularly to a lift assembly which is pivotally attached to a vehicle and includes a wheeled structure to travel along a roadway concurrently with the vehicle being maintained in the raised position.

### BACKGROUND OF THE INVENTION

Jacks and jack assemblies are normally supplied as original equipment when a vehicle is purchased. These are used to lift the vehicle so that a flat tire may be changed. When a flat tire or disabled wheel occurs the operator will drive the vehicle off the road to an area which is safe to change the tire. The jack is removed from its storage area and placed beneath the vehicle in supporting engagement therewith and adjacent the wheel well associated with the flat tire or disabled wheel. A lug wrench or other implement is then connected to the body of the jack to serve as a lever for the mechanism which raises and lowers a lifting arm. This lifting arm is in supporting engagement with the vehicle. The operator of the vehicle manually applies a force to the lug wrench to elevate the vehicle until the flat tire or disabled wheel is no longer on the roadway.

Use of these original equipment jacks is often problematic. Primarily, excessive force is required to raise the vehicle to a height sufficient to remove the flat tire. This force is beyond the physical capabilities of many individuals. This is especially true if the vehicle is a pickup truck, a SUV (Sport Utility Vehicle) or a recreational vehicle. Another problem is that if the vehicle and jack are not located on a level and substantially hard surface there is the possibility that the vehicle will shift, forward or backward, once it is elevated. This can result in the vehicle falling off the jack with possible injury to the operator and damage to the vehicle. Proper placement of the jack can also be a problem. If not correctly placed the jack may not lift the vehicle sufficiently to remove the flat tire. Also, damage to the underside of the vehicle could result if the jack is placed in an area that is not properly reinforced to support the weight of the vehicle.

### DESCRIPTION OF THE PRIOR ART

A large variety of jacks and/or lift assemblies have been devised to facilitate the lifting of the vehicle in an emergency situation without the need for manual exertion. Such assemblies include hydraulically operated jacks and lift assemblies which are built into the vehicle. Other attempts to facilitate the repair of a flat tire or disabled wheel include the provision of emergency wheels and/or wheel dollies. Attempts have been made to mount, either temporarily or permanently, relatively small wheel assemblies adjacent the flat tire or disabled wheel. One of the problems associated with these devices is the difficulty of securely attaching them to the wheel or vehicle so that the vehicle may be safely moved.

The instant inventor has recently been awarded U.S. Pat. No. 6,843,487, the entire contents of which are incorporated herein by reference. The '487 patent discloses a lift assembly for a vehicle which is designed to be secured to the vehicle at one of a plurality of predetermined locations 50. The mounting assembly 16 comprises a plurality of mounting members 18, 20 and a gripping assembly 24 which comprises an inflatable bladder, the inflatable bladder being secured to a portion of the vehicle 11. The preferred locations to attach the lift assembly to the vehicle are generally indicated at 50 which will provide maximum support for the disabled wheel and are located adjacent the wheel wells of the vehicle. The lift mechanism 36 is then attached to the mounting assembly utilizing the connector assembly 40. Subsequently, the lift mechanism may be activated to lift the disabled wheel off the ground and provide support while the vehicle is being moved. While the '487 patent suggests that the mounting assembly can be permanently secured to the vehicle, it fails to teach or suggest permanent mounting of the lift mechanism to said mounting assembly. Such mounting would be problematic in the '487 patent since the lift mechanisms extend downwardly toward the road surface, and would be subject to wind and road debris. Therefore, in accordance with the '487 patent, when the lift assembly is to be utilized the vehicle operator must exit the vehicle and physically attach the lift mechanisms to the mounting assembly and connect a source of pressurized fluid to the lift mechanism to activate it, which may be both a daunting and dangerous task dependent upon the location of the vehicle, the ambient conditions and excessive traffic near the disabled vehicle.

The present invention amplifies the teachings of the '487 patent by providing permanently attached lifting means associated with means for retraction of said lifting means from a storage position to a usage position, and provision of means for activating the lifting mechanism, all of which can be accomplished by the operator while remaining safely within the vehicle.

U.S. Pat. No. 5,893,571 issued to Nowell discloses a wheeled dolly which is formed of two halves 12 and 14. These halves are positioned beneath the flat tire or disabled wheel and then brought together. This raises the flat tire or disabled wheel off the ground. The vehicle may now use the wheels 22 of the dolly to move the vehicle to a location where the disabled wheel can be repaired. The operation of this device is beyond the ability of the average motorist. Also, the device occupies valuable storage space in the vehicle.

U.S. Pat. No. 4,465,412 issued to Murillo discloses a wheeled dolly which employs three wheels. The flat tire or disabled wheel is driven up ramp 12 into cradle 11. Front caster wheel 4 and rear wheels 3 are then utilized to support the flat tire and move the vehicle. While greater ease of use may be provided, in comparison to U.S. Pat. No. 5,893,571 the problem of occupying valuable storage space nevertheless remains. Another problem with wheeled dollies is ground clearance of the vehicle. When a tire is flat or disabled it is normally completely deflated. This decreases the ground clearance at the effected wheel. The wheeled dollies do not substantially increase the ground clearance because they normally employ small wheels. As a result, if the vehicle is driven over a “speed bump” the underside of the vehicle could be caught or damaged by the bump. The vehicle could, in fact be raised sufficiently, by the speed bump, to have the disabled wheel come off the dolly.

U.S. Pat. No. 5,765,810 issued to Mattera discloses a jacking system for a vehicle wherein four air jacks 40 are normally attached to the vehicle axles 14. Each air jack is connected to air compressor 20. A control panel 30 is connected to the air compressor for controlling the air pressure to each air jack. Any number of air jacks may be activated so that only a portion, or the entire vehicle, can be raised. The air jacks are designed for stationary use. The vehicle cannot be moved when the jacks are in use.

Such prior art jacks and lift assemblies fail to teach or disclose the mobile lift assembly of the instant invention. The prior art wheeled dollies fail to provide a mechanism to easily raise up the vehicle to provide sufficient ground clearance when the vehicle is being transported to a repair facility. The pneumatic air jack system fails to provide means to permit permanent attachment of the entire device to the vehicle. Further, there is no disclosure in the prior art of activation means, operable from within the vehicle, to pivot the lift assembly into its operating position and extend the support assembly into its operating position.

### SUMMARY OF THE INVENTION

The present invention is directed to a lift assembly constructed and arranged to movably support a vehicle, which comprises a mounting assembly adapted for mechanical engagement with a predetermined portion of a vehicle; a support assembly in mechanical engagement with said mounting assembly and including at least one support member positionable in engaging relation with a supporting surface; an activation assembly in mechanical engagement with said support assembly, said activation assembly constructed and arranged for providing reciprocal articulation of said support assembly from a stored and retracted position to a deployed and extended position; whereby said support member is activatable to supportably and movably engage said support surface.

Accordingly, it is an objective of the instant invention to provide a lift assembly which is permanently secured to a vehicle at a plurality of predetermined locations, preferably adjacent a wheel well of the vehicle, and instantly deployable from within the vehicle, thereby eliminating the inconvenience and problems associated with replacing the flat tire or disabled wheel with a “spare tire” while in an inconvenient or undesirable location.

It is a further objective of the instant invention to provide a lift assembly that is relatively compact and may be easily stored within a convenient storage area of the vehicle without the necessity of utilizing storage areas that could otherwise be used for cargo.

It is yet another objective of the instant invention to provide a lift assembly which includes a mounting assembly connected to the vehicle at specifically predetermined locations which provide sufficient support to transport the vehicle to a repair facility or other location. The mounting assembly allows the support member to articulate from a first “stored” position to a second “use” position.

It is yet a further objective of the instant invention to provide a lift assembly which includes a lift mechanism and a support member. The support member is structured to engage and travel along the ground, roadway or other supporting surface on which the vehicle is disposed, and thereby allow the vehicle to be safely transported to a repair facility or other location.

In accordance with the instant invention the term “reciprocal articulation” is understood to mean translational movement of the support assembly from a storage position in which it is retracted to its storage height to a deployed and extended position wherein is has been withdrawn from its storage position and further extended to a point where it supports and lifts the vehicle from the supporting surface which is in juxtaposed relation beneath the vehicle. Also in accordance with the instant invention the term “movably engage” is understood to mean the position of the support member wherein it supports and lifts the vehicle upon the support surface in a manner which permits movement of the vehicle along the supporting surface.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

For an understanding of the nature of the present invention, reference should be had to the following detailed description taken in conjunction with the accompanying drawings in which:

FIG. 1 is a schematic representation of the lift assembly in its support position on a vehicle.

FIG. 2 is a front detailed view of the support member.

FIG. 3 is a schematic representation of a second embodiment of the lift assembly.

### DETAILED DESCRIPTION OF THE INVENTION

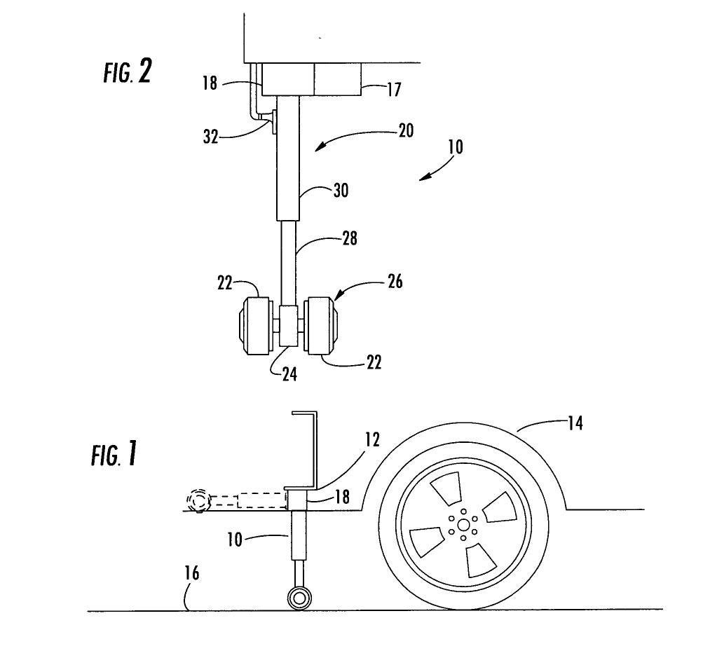

As shown in the accompanying drawings, the instant invention is directed to a lift assembly, generally indicated as 10, which is constructed to support any of a plurality of different predetermined portions 12 of a vehicle, such as when the vehicle has a flat tire or similar emergency. Accordingly, each of the predetermined portions 12 of the vehicle is generally disposed adjacent a different wheel well, generally indicated as 14. Therefore, operation of the lift assembly 10 serves to raise the flat tire or disabled wheel above the ground, road or other supporting surface 16 on which the vehicle is disposed. The lift assembly 10, as depicted in FIG. 1, is disposed in supporting engagement with one of the plurality of predetermined portions 12. The actual structure and location of the predetermined portion 12 of the vehicle may of course vary dependent on the make, model, size, configuration, etc. of the vehicle. It is emphasized that the predetermined portions 12 intended to be engaged by the lifting assembly are typically located on an undercarriage and/or frame of the vehicle rather than on a fender or other exterior portion of the vehicle.

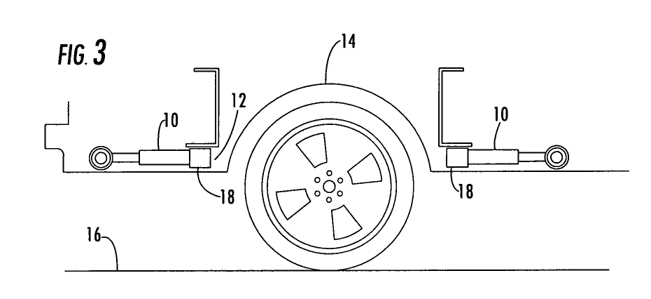

One preferred, albeit non-limiting, embodiment of the lift assembly as shown in FIG. 1 includes a mounting assembly generally indicated as 18. The mounting assembly 18 is attached to the vehicle at one of the predetermined portions 12. It is also connected to the support assembly 20 at an upper portion thereof. An activation assembly 17, FIG. 2, is connected to both the mounting assembly 18 and support assembly 20. As shown in FIG. 1 it is used to move the support member from its stored and retracted position (shown in phantom) to its deployed and extended position. It may comprise an electrically, pneumatically or hydraulically operated device. The activation assembly is preferably controlled from inside of the vehicle. Means to control the activation assembly can also be located outside of the vehicle and wirelessly connected to the activation assembly. Once the support assembly is in its deployed and extended position, the mounting assembly employs means (not shown) to lock it in place during operation.

With reference to FIG. 2, the support assembly 20 comprises a support member, generally indicated as 26, disposed and structured for travel along a supporting surface or road 16 on which the vehicle is traveling. The support member 26 may comprise one or more wheels, tires, rollers, balls, etc. as at 22. In a preferred embodiment, the support member comprises a pair of spaced apart but interconnected wheel structures 22 mounted to one end of the support assembly 20. Both wheels 22 are connected by stub axles to a journal box 24. The journal box 24 and the connecting axles are cooperatively structured to allow pivotal or rotational movement of the support member 26 about the longitudinal axis of the support assembly 20 in order to accommodate changes in movement of the vehicle as it travels along supporting surface 16. The opposite end of support assembly 20, relative to support member 26, is connected to mounting assembly 18.

Referring primarily to FIG. 2, each of the support assemblies 20 comprise a piston and cylinder assembly. Specifically, the piston and cylinder assembly includes a piston element 28 mounted within and movable relative to a cylinder element 30. In the embodiment of FIG. 1 the lift assembly 10, shown in phantom, is in a substantially retracted position. The majority of the length of the piston 28 is within the cylinder 30. Upon the introduction of air or other fluids under pressure into the cylinder 30, by means of a valve structure 32, the piston 28 will be forced outwardly from the interior of the cylinder 30 and into a longitudinally extended and operative position shown in FIG. 2. Control of the fluids to activate the piston are by means located within the vehicle. Accordingly the deployed and extended position is at least partially defined by the one or more support assemblies 20 being longitudinally extended or expanded to a length sufficient to raise the flat tire or disabled wheel off of the supporting surface 16. The entire operation of the lift assembly can be controlled from within the vehicle.

In a second embodiment, shown in FIG. 3, a plurality of lift assemblies are mounted at each wheel. Upon activation of the lift assembly both support assemblies 20 are rotated from their stored position, as seen in FIG. 3 to their operative position by activation assembly 17. Air or another fluid is then introduced into cylinders 30 to extend pistons 28 until support members 26 engage the supporting surface. Additional air or fluid is introduced into the cylinders to extend the pistons a sufficient distance to raise the flat tire off of the supporting surface.

While not specifically disclosed, the source of pressurized fluid used to expand one or all of the support members 20 may come from a common source. As such, the source or supply of pressurized fluid may be a canister or container maintained under sufficient pressure and having a sufficient quantity of fluid contained therein to raise all of the lift assemblies. Naturally, a variety of other sources of pressurized fluids may be utilized to operate and activate the pistons and cylinders.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A lift assembly constructed and arranged to movably support a vehicle, comprising:
a mounting assembly adapted for mechanical engagement with a predetermined portion of a vehicle;
a support assembly in mechanical engagement with said mounting assembly and including at least one support member positionable in engaging relation with a supporting surface;
an activation assembly in mechanical engagement with said support assembly, said activation assembly constructed and arranged for providing reciprocal articulation of said support assembly from a stored and retracted position to a deployed and extended position;
whereby said support member is activatable to supportably and movably engage said support surface.

2. A lift assembly in accordance with claim 1, wherein said support assembly comprises a lift mechanism positionable between said mounting assembly and said support member.

3. A lift assembly in accordance with claim 2, wherein said lift mechanism is constructed and arranged to position said support assembly into said deployed and extended position.

4. A lift assembly in accordance with claim 3, wherein said lift mechanism includes fluidic means to position said support assembly into said deployed and extended position.

5. A lift assembly in accordance with claim 4, wherein said fluidic means to position said support assembly into said deployed and extended position comprises pneumatic means.

6. A lift assembly in accordance with claim 3, wherein said deployed and extended position of said support assembly is at least partially defined by said lift mechanism extending upwardly from said support member a distance sufficient to raise a tire of a vehicle above said supporting surface.

7. A lift assembly in accordance with claim 1, wherein said mounting assembly is adapted for mechanical engagement with a vehicle at a plurality of different predetermined portions.

8. A lift assembly in accordance with claim 7, wherein one of said plurality of different predetermined positions includes multiple positions adjacent a single wheel of a vehicle.

9. A lift assembly in accordance with claim 1, wherein said activation assembly is controllable by means located within a vehicle.

10. A lift assembly in accordance with claim 1, wherein said support member comprises wheels.

11. A lift assembly in accordance with claim 1, wherein said support member comprises tires.

12. A lift assembly in accordance with claim 1, wherein said support member comprises rollers.

13. A lift assembly in accordance with claim 1, wherein said support member comprises balls.

14. A lift assembly constructed and arranged to movably support a vehicle comprising:
a mounting assembly adapted for mechanical engagement with a predetermined portion of a vehicle;
a support assembly in mechanical engagement with said mounting assembly and including at least one support member positionable in engaging relation with a supporting surface;
an activation assembly in mechanical engagement with said support assembly, said activation assembly constructed and arranged for providing reciprocal articulation of said support assembly from a stored and retracted position to a deployed and extended position;
said support assembly further comprising a lift mechanism positionable between said mounting assembly and said support member and arranged to activate said support assembly into said deployed and extended position; and
whereby said support member is activatable to supportably and movably engage said support surface.

15. A lift assembly in accordance with claim 14, wherein said deployed and extended position is at least partially defined by said lift mechanism extending upwardly from said support member a sufficient distance to raise a tire of a vehicle above the supporting surface.

16. A lift assembly in accordance with claim 14, wherein said lift mechanism comprises a piston and cylinder structure operable by a fluid to dispose said support assembly into said deployed and extended position.

17. A lift assembly in accordance with claim 16, wherein said piston and cylinder structure are pneumatically operable.

18. A lift assembly in accordance with claim 14, wherein said mounting assembly is adapted for mechanical engagement with a vehicle adjacent one of a plurality of different predetermined portions thereof.

19. A lift assembly in accordance with claim 18, wherein one of said plurality of different predetermined positions includes multiple positions adjacent a single wheel of a vehicle.

20. A lift assembly in accordance with claim 14, wherein said activation assembly is controllable by means located within a vehicle.

21. A lift assembly in accordance with claim 14, wherein said support means comprises wheels.

22. A lift assembly in accordance with claim 14, wherein said support means comprises tires.

23. A lift assembly in accordance with claim 14, wherein said support means comprises rollers.

24. A lift assembly in accordance with claim 14, wherein said support means comprises balls.
